(19) United States
(12) Patent Application Publication
(10) Pub. No.: US 2014/0032238 A1
(43) Pub. Date: Jan. 30, 2014

(54) HOME MEDICAL CARE SUPPORT APPARATUS AND HOME MEDICAL CARE SUPPORT SYSTEM

(71) Applicants: Toshiba Medical Systems Corporation, Otawara-shi (JP); Kabushiki Kaisha Toshiba, Minato-ku (JP)

(72) Inventors: Longxun PIAO, Nasushiobara-shi (JP); Satoshi Ikeda, Yaita-shi (JP); Shinya Sugiyama, Nasushiobara-shi (JP)

(73) Assignees: Toshiba Medical Systems Corporation, Otawara-shi (JP); Kabushiki Kaisha Toshiba, Minato-ku (JP)

(21) Appl. No.: 14/040,164

(22) Filed: Sep. 27, 2013

Related U.S. Application Data
(63) Continuation-in-part of application No. PCT/JP2013/003900, filed on Jun. 21, 2013.

(30) Foreign Application Priority Data
Jun. 28, 2012 (JP) 2012-145251

(51) Int. Cl. G06Q 50/22; G06Q 10/06

(52) U.S. Cl. CPC G06Q 50/22; G06Q 10/06311
USPC 705/2

(57) ABSTRACT

A home medical care support apparatus of an embodiment includes: an alarm level determination unit that receives alarm information issued from a home-care patient and home medical equipment and determines an alarm level indicating a degree of urgency; a storage unit that stores a home visit schedule of each of a plurality of medical staffs who perform medical support for the home-care patient; and a medical staff calculation unit that calculates, from among the plurality of medical staffs who perform medical support for the home-care patient, qualified staffs who can perform the support based on route information included in the home visit schedule information and the alarm level.

### CROSS-REFERENCE TO RELATED APPLICATION

This application is a continuation-in-part of International Application No. PCT/JP2013/003900, filed on Jun. 21, 2013, which is based upon and claims the benefit of priority from the prior Japanese Patent application No. 2012-145251, filed on Jun. 28, 2012, the entire contents of which are incorporated herein by reference.

### FIELD

An embodiment described below relates to a home medical care support system, in which a plurality of medical staffs including a doctor and a nurse, support a home-care patient in a team environment and, more particularly, relates to a home medical care support apparatus and a home medical care support system capable of promptly sending a suitable medical staff to the home-care patient in response to and depending on alarm information from the home-care patient and home medical equipment.

### BACKGROUND

A home medical care support system has been developed for support of long-term medical treatment. Generally, in home medical care, a plurality of medical staffs including a doctor and a nurse, provide medical care to a home-care patient in a team environment. The home medical care support system is configured such that when a notification is given from the home-care patient or when abnormality is transmitted (alarm is issued) from medical equipment used in a patient's home, some staffs in the team rush to the home-care patient.

However, even if the system is configured to send the medical staffs in a predetermined order of priority in response to issuance of the alarm from the home-care patient, it may take time for the staffs to arrive at the patient's home (alarm source) depending on a status (whether the doctor is examining his patient or he is absent due to a home visit) of the doctor at that time and a distance from the patient's home. Further, it may take time to determine who of the team is to be sent and, thus, a quick response cannot be achieved.

### BRIEF DESCRIPTION OF THE DRAWINGS

FIG. 1 is a block diagram of a home medical care support system according to an embodiment;

FIG. 2 is a view schematically illustrating operation of the home medical care support system according to the embodiment;

FIG. 3 is a view illustrating a component block related to an alarm level determination unit in the embodiment;

FIG. 4 is a view illustrating a component block related to a medical staff calculation unit in the embodiment;

FIG. 5 is a view illustrating a component block related to a presence calculation unit in the embodiment;

FIG. 6 is a view illustrating a component block related to a suitable staff calculation unit in the embodiment;

FIG. 7 is a view illustrating a component block related to a notification unit and a reply conformation unit in the embodiment; and

FIG. 8 is a flowchart illustrating operation of the home medical care support system according to the embodiment.

### DETAILED DESCRIPTION

A home medical care support apparatus of an embodiment includes: an alarm level determination unit that receives alarm information issued from a home-care patient and home medical equipment and determines an alarm level indicating a degree of urgency; a storage unit that stores a home visit schedule of each of a plurality of medical staffs who perform medical support for the home-care patient; and a medical staff calculation unit that calculates, from among the plurality of medical staffs who perform medical support for the home-care patient, qualified staffs who can perform the support based on route information included in the home visit schedule information and the alarm level.

Hereinafter, a home medical care support system according to an embodiment will be described in detail with reference to the drawings. Throughout the drawings, the same reference numerals are used to designate the same or similar components.

### First Embodiment

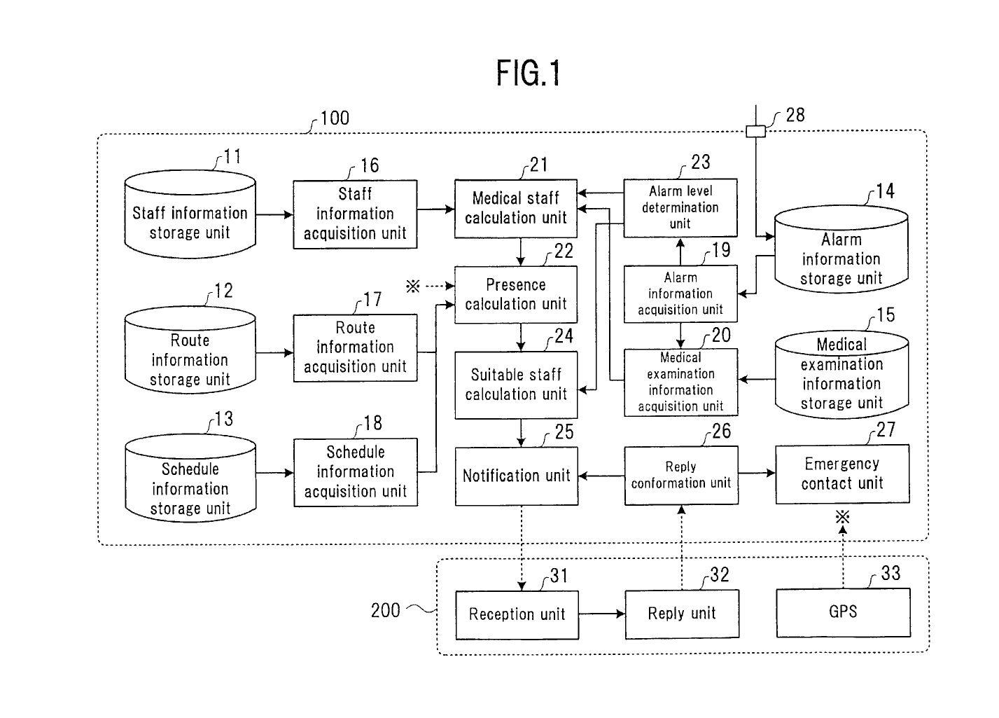

FIG. 1 is a block diagram of a home medical care support system according to an embodiment. The home medical care support system includes a home medical care support apparatus 100 installed in a medical institution such as a hospital and a terminal device 200 used by a medical staff such as a doctor. Although the terminal device 200 is owned by each medical staff, only one terminal device 200 is illustrated in the example of FIG. 1.

The home medical care support apparatus 100 (hereinafter, abbreviated as “support apparatus”) includes, as databases for storing various information, a staff information storage unit 11, a route information storage unit 12, a schedule information storage unit 13, an alarm information storage unit 14, and a medical examination information storage unit 15.

The staff information storage unit 11, the route information storage unit 12, and the schedule information storage unit 13 are connected respectively to a staff information acquisition unit 16, a route information acquisition unit 17, and a schedule information acquisition unit 18. To the alarm information storage unit 14 and medical examination information storage unit 15, an alarm information acquisition unit 19 and a medical examination information acquisition unit 20 are connected respectively. The staff information acquisition unit 16 is connected to a medical staff calculation unit 21. The route information acquisition unit 17 and schedule information acquisition unit 18 are connected to a presence calculation unit 22. The medical staff calculation unit 21 is connected to the presence calculation unit 22.

Alarm information acquired in the alarm information acquisition unit 19 is supplied to an alarm level determination unit 23 and medical examination information acquisition unit 20. A determination result made by the alarm level determination unit 23 and medical examination information acquired in the medical examination information acquisition unit 20 are supplied to the medical staff calculation unit 21. The presence calculation unit 22 is connected to a suitable staff calculation unit 24. The suitable staff calculation unit 24 is connected to a notification unit 25.

The notification unit 25 can communicate with the terminal device 200 and issues a support request to the terminal device 200 upon reception of the alarm information. The notification unit 25 is connected to a reply conformation unit 26 and thus can receive a reply from the terminal device 200 through the reply conformation unit 26. The reply conformation unit 26 is connected to an emergency contact unit 27.

The terminal device 200 can communicate with the support apparatus 100 using a network or a dedicated communication application. The terminal device 200 is, e.g., a mobile phone, and includes a reception unit 31 that receives the support request from the notification unit 25, a reply unit 32 that notifies the reply conformation unit 26 of reception of the support request, and a GPS (Global Positioning System) 33 that generates position information indicating a current position of the terminal device 200. The position information from the GPS 33 is supplied to the presence calculation unit 22.

The alarm information storage unit 14 receives the alarm information from a home-care patient, and alarm information from medical equipment (home medical equipment) installed at a patient's home, through a network interface (I/F) 28. The received alarm information is stored in the alarm information storage unit 14. Hereinafter, the alarm information from the home-care patient and alarm information from the home medical equipment are collectively referred to merely as “alarm information”. Further, hereinafter, a residence (home of the patient to be visited) of the home-care patient who has issued the alarm is sometimes referred to as “alarm source”.

The following describes operation of the home medical care support system of the embodiment. In the home medical care support system of FIG. 1, a plurality of medical staffs including a doctor, a nurse, a care worker, and the like provide medical support for the home-care patient in a team environment. When receiving the alarm issued from the home-care patient and home medical equipment, the home medical care support system calculates suitable medical staffs (hereinafter, referred to as “suitable staffs”) depending on an alarm level. Further, the home medical care support system determines a current status and a current location of each suitable staff and makes notification to the suitable staff to instruct him or her to visit the home-care patient.

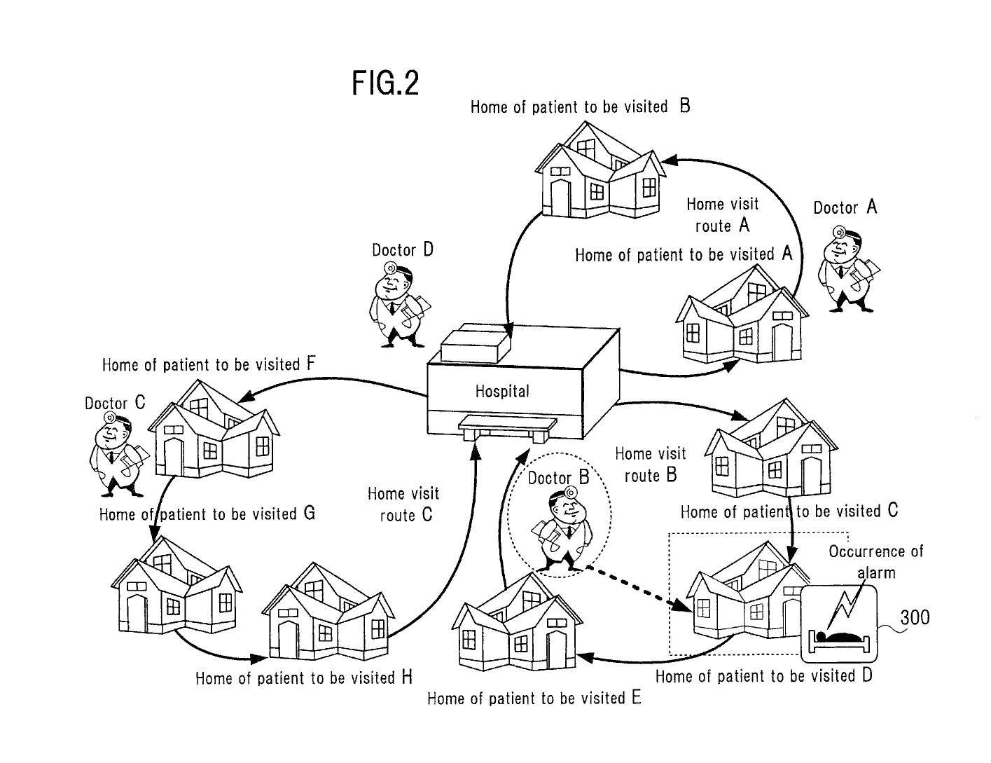

FIG. 2 is a view schematically illustrating operation of the embodiment. In FIG. 2, a team is constituted by a plurality of medical staffs including a doctor, a nurse, a care worker, and the like, and current positions of doctors A to D of the respective teams are shown.

For example, the doctor A visits patients at homes A and B along a home visit route A. The doctor B visits patients at homes C, D, and E along a home visit route B. The doctor C visits patients at homes F, G, and H along a home visit route C. The doctor D is assumed to be in a hospital. All the homes A to H are assumed to be provided with an alarm issuance unit 300. For descriptive convenience, the alarm issuance unit 300 is shown only in the home D in FIG. 2.

For example, in FIG. 2, the doctor A is assumed to be examining a patient at the home A, the doctor B is assumed to be in the way back to his hospital after examining a patient at the home E, and the doctor C is assumed to be examining a patient at the home F. In these situations, when an alarm is issued from a home-care patient of the home D, the support apparatus 100 calculates locations of the doctors in the team and determines the alarm level to thereby calculate a suitable medical staff (suitable staff) for supporting (making a home visit) a patient of the home D. Then, the support apparatus 100 notifies a suitable staff (in this case, the doctor B) who is near the alarm source (home D) of reception of the alarm. As a result, the doctor B who receives the notification returns to the home D to support (examine) the patient.

If contact with the doctor B is not made or if the doctor B is not available, the support system 100 selects the second suitable staff (e.g., doctor D) based on schedule information, route information, and current location, and makes notification to the selected staff (doctor D) to instruct him or her to visit the alarm source. Further, if contact with the doctor D is not made or if the doctor D is not available, the support system 100 selects the doctor C and instructs him or her to visit the alarm source.

The alarm is issued, for example, when the patient him- or herself pushes a contact button (alarm button). For example, in order for the home-care patient to notify the hospital of the degree of urgency, it is preferable to previously determine the number of times or frequency of depression of the contact button. Meanwhile, the home medical equipment measures data (vital information) indicating a physical condition, such as body temperature, blood pressure, number of pulses, and blood sugar level, and notifies the hospital of a result of the measurement as the alarm. Moreover, the alarm is issued upon occurrence of an abnormal state like unplugging of a plug.

When the contact button is pushed more than once or when measurement data of the home medical equipment indicates an abnormal value, the support system 100 determines that the alarm level is high. Then, the support system 100 selects doctors who are available as the suitable staffs and makes notification to a doctor nearest the alarm source among the suitable staffs. Further, since a case where a power plug of the home medical equipment is unplugged or intravenous drip comes off can be handled not only by a doctor but also a nurse, the selection of the suitable staff is made depending on the alarm level.

Further, the support system 100 calculates a prioritized list of medical staffs and makes notification to a doctor having a highest priority. When no reply is returned, the support system 100 makes notification to a doctor having the second highest priority. In the worst-case scenario, the support system 100 makes notification to a previously set emergency contact.

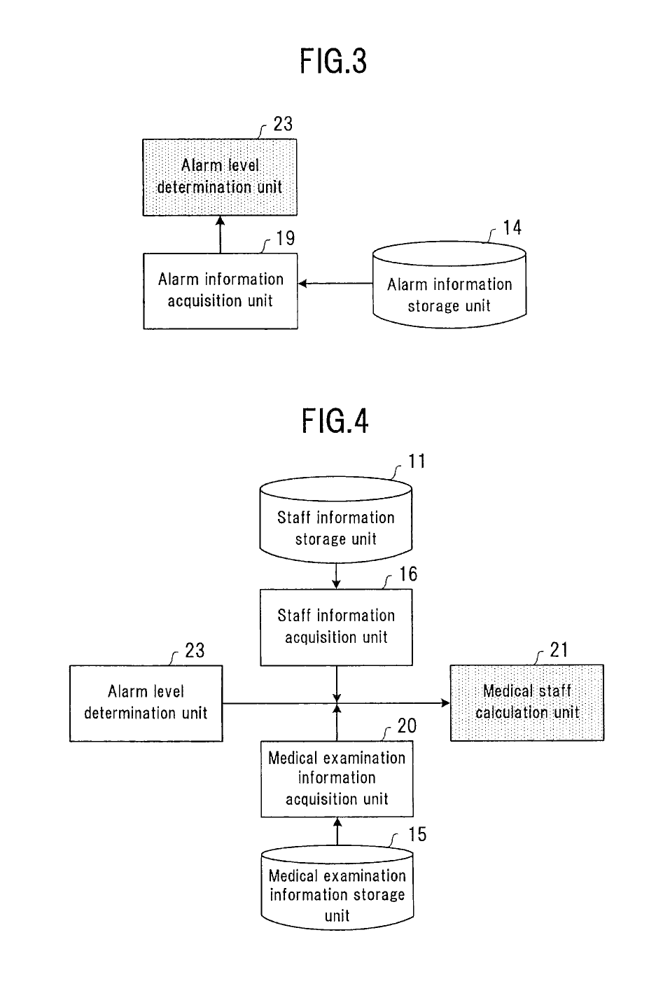

The following describes roles and operations of respective components constituting the home medical care support system of FIG. 1 by dividing the components into blocks of FIGS. 3 to 7, respectively.

FIG. 3 is a view illustrating a component block related to the alarm level determination unit 23. In FIG. 3, upon reception of the alarm from the alarm issuance unit 300, the alarm information storage unit 14 stores therein information corresponding to the alarm.

The alarm is issued not only from the home-care patient him- or herself, but also from the home medical equipment. The alarm from the patient corresponds to depression information generated when the patent depresses the contact button. For example, the number of pressing times, frequency, and time length of depression of the contact button and a disease state of the patient are stored in the alarm information storage unit 14. As the alarm from the home medical equipment, measurement data (vital information indicating a physical condition, such as body temperature, blood pressure, number of pulses, and blood sugar level) from the home medical equipment (pressure measuring device, mechanical ventilator, electrocardiograph, etc.) is received. Moreover, the alarm information storage unit 14 stores, for example, a degree of change in the measured value, an elapsed time of the change, a rate of the change, and the like. Moreover, the alarm information storage unit 14 stores abnormality information (information indicating, e.g., that reception of measurement data is interrupted for a predetermined length of time due to unplugging of a power plug or failure) of a measuring instrument.

The alarm information acquisition unit 19 acquires the alarm information stored in the alarm information storage unit 14, and supplies the acquired alarm information to the alarm level determination unit 23. When the alarm is issued from the home-care patient, the alarm level determination unit 23 determines the alarm level based on a change level of the disease state of the patient, the number of pressing times, frequency, and time length of depression of the contact button, and the like. For example, the frequency of depression of the contact button of equal to or more than ten times per minute is determined to be “Level 5”, the frequency of five times to ten times per minute is determined to be “Level 3”, and the frequency of equal to or less than five times is determined to be “Level 1”. When the alarm is issued from the home medical equipment, the alarm level determination unit 23 determines the alarm level based on the degree of change in the measured value, elapsed time of the change, rate of the change, and the like. The alarm level indicates the urgency degree, and the higher the alarm level is, the higher the urgency degree.

FIG. 4 is a view illustrating a component block related to the medical staff calculation unit 21. In FIG. 4, the staff information storage unit 11 stores information on the medical staffs involved in the home medical care. The medical staffs include a doctor, a nurse, a care worker, and the like. Moreover, the staff information storage unit 11 stores information on a type (doctor, nurse, care worker, etc.) of the medical staff, information on services to offer (cardiovascular department, cranial nerve surgery, digestive organs department, respiratory organs department, etc.), and the like. The staff information acquisition unit 16 acquires the medical staff information from the staff information storage unit 11.

The medical examination information storage unit 15 stores therein past medical examination information on the patient. For example, the medical examination information storage unit 15 stores medical chart information on the patient, vital information on the patient, and the like. The medical examination information acquisition unit 20 acquires the medical examination information on the home-care patient from the medical examination information storage unit 15.

The medical staff calculation unit 21 receives the medical staff information from the staff information acquisition unit 16. Moreover, the medical staff calculation unit 21 receives the alarm level and alarm information from the alarm level determination unit 23, as well as the medical examination information on the patient from the medical examination information acquisition unit 20. The medical staff calculation unit 21 calculates, from among the medical staffs, qualified staffs who can support the patient as the alarm source. Moreover, the medical staff calculation unit 21 calculates the type (doctor, nurse, care worker, etc.) of each qualified staff who can support the patient based on the alarm level and alarm information.

For example, for a patient who has issued a low level alarm, staffs each having skills equivalent to or higher than the care worker are calculated as the qualified staffs. For a patient who has issued a middle level alarm and requires a simple procedure, staffs having skills equivalent to or higher than the nurse are calculated as the qualified staffs. For a patient who has issued a high level alarm and requires an urgent procedure, staffs having skills equivalent to or higher than the doctor are calculated as the qualified staffs.

Moreover, the medical staff calculation unit 21 acquires, from the medical examination information on the patient, corresponding information such as department information, medical staff information (primary doctor, primary clinic, etc.), medical chart information, vital information, and calculates medical staffs corresponding to the patient. Then, the medical staff calculation unit 21 calculates, based on the type of the medical staff, department information, doctor information, and the like, qualified staffs who can support the patient as the alarm source.

FIG. 5 is a view illustrating a component block related to the presence calculation unit 22. In FIG. 5, the route information storage unit 12 stores therein route information based on schedule information created when the medical staffs including a doctor, a nurse, and the like make a home visit for a plurality of home-care patients. For example, in FIG. 2, the route information storage unit 12 stores information on the home visit route or home of a patient to be visited. The route information acquisition unit 17 acquires the route information of each medical staff from the route information storage unit 12.

The schedule information storage unit 13 stores therein schedule information on the medical staffs including a doctor, a nurse, and the like, for example, information on date and hour of visit to the home of a patient to be visited, attendance/leaving time, and the like. The schedule information acquisition unit 18 acquires the schedule information on each medical staff from the schedule information storage unit 13.

The presence calculation unit 22 acquires the schedule information and route information on the medical staffs (qualified staffs) calculated by the medical staff calculation unit 21, and calculates their current location using a TRPS (RealTime Positioning System). In the present embodiment, the location is calculated by using information from the GPS 33 of the terminal device 200. Moreover, the presence calculation unit 22 calculates whether each qualified staff is moving or examining. This determination may be made depending on the visit date, and hour and current location. That is, the presence calculation unit 22 may determine “examining” when the qualified staff is moving. Further, the presence calculation unit 22 may determine that the qualified staff that has clocked out is free.

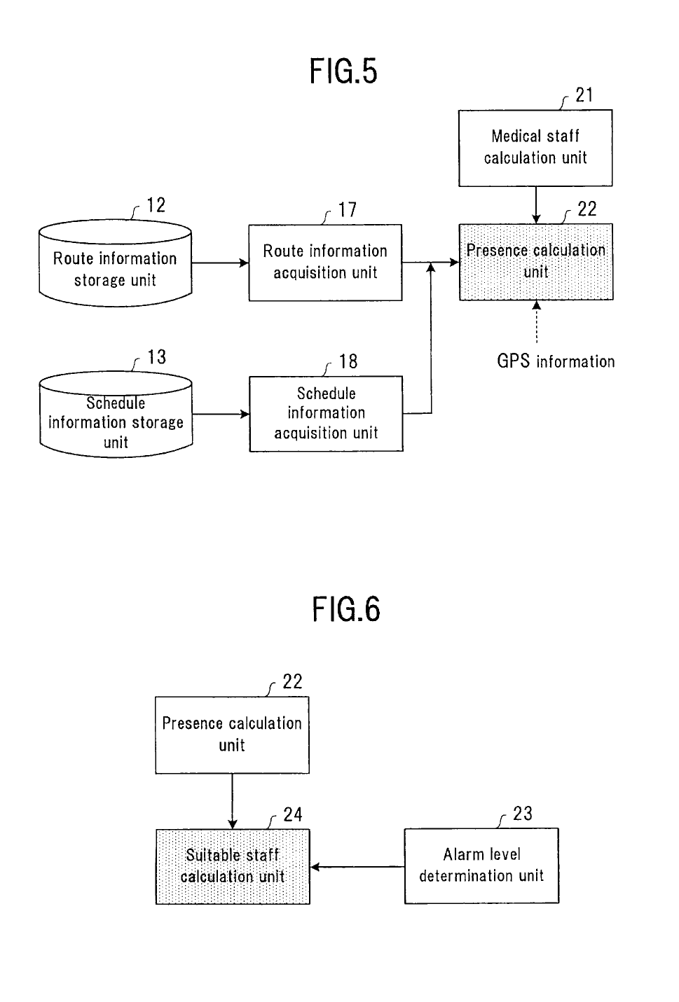

FIG. 6 is a view illustrating a component block related to the suitable staff calculation unit 24. In FIG. 6, the suitable staff calculation unit 24 calculates travel time to the alarm source based on the position and status of the qualified staff calculated by the presence calculation unit 22. Moreover, the suitable staff calculation unit 24 calculates suitable medical staffs (suitable staffs) for supporting the home-care patient depending on the alarm level determined by the alarm level determination unit 23.

For example, when the alarm level is high, the suitable staffs are selected in ascending order of time required to arrive at the alarm source. When the alarm level is low, the suitable staffs are selected based on the type of the medical staff and in ascending order of time required to arrive at the alarm source. When the selected doctor is examining another home-care patient, arrival time to the alarm source may be calculated based on past examination time (average examination time+travel time).

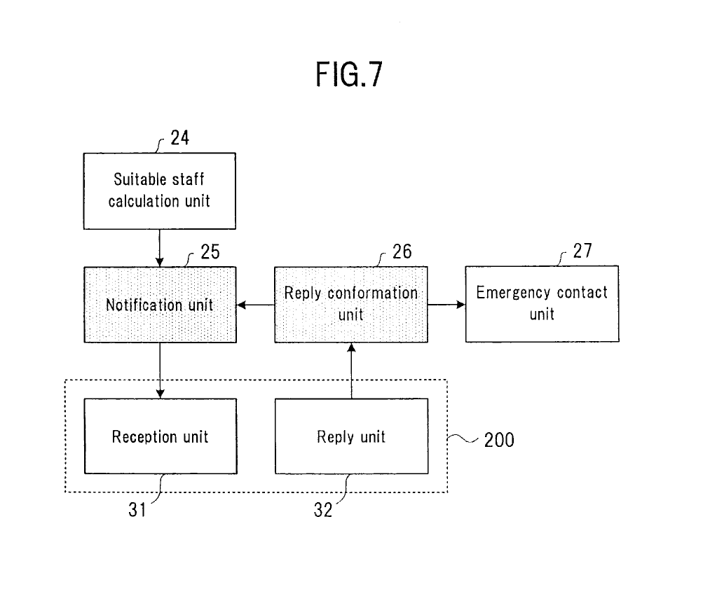

FIG. 7 is a view illustrating a component block related to the notification unit 25 and reply conformation unit 26. In FIG. 7, the notification unit 25 transmits the alarm information and the like to the terminal device 200 of the suitable staff in the order of priority calculated by the suitable staff calculation unit 24 so as to make notification of a support request. The notification to the terminal device 200 may be made by e-mail or by using a dedicated communication application.

The reply conformation unit 26 confirms reply information transmitted from the reply unit 32 of the terminal device 200 of the suitable staff. When there is a reply from the suitable staff, the confirmation is completed. On the other hand, when the suitable staff refuses a reply, or when there is no reply from the suitable staff, the reply conformation unit 26 notifies the notification unit 25 of the corresponding information. Then, the notification unit 25 notifies a suitable staff having the next highest order of priority of the support request. When it is determined, based on a result of confirmation made by the reply conformation unit 26, that there is no replay from all the suitable staffs or all the suitable staffs are unavailable, the emergency contact unit 27 notifies a previously registered emergency contact of the corresponding information. Then, emergency information is notified from the emergency contact so as to cause someone to visit the alarm source.

As described above, when receiving the alarm issued from the home-care patient or home medical equipment, the support apparatus 100 confirms the location of each medical staff corresponding to the alarm level. Then, the support apparatus 100 selects the suitable staffs for the support in a prioritizing manner based on statuses or position information of the medical staffs, and makes notification of a support request to the terminal device 200 of each selected suitable staffs in the order of priority. When the suitable staff having a higher priority is not available, the notification of the support request can be made to a suitable staff having the next highest order of priority. In the worst-case scenario, the support apparatus 100 can make the notification to a previously set emergency contact.

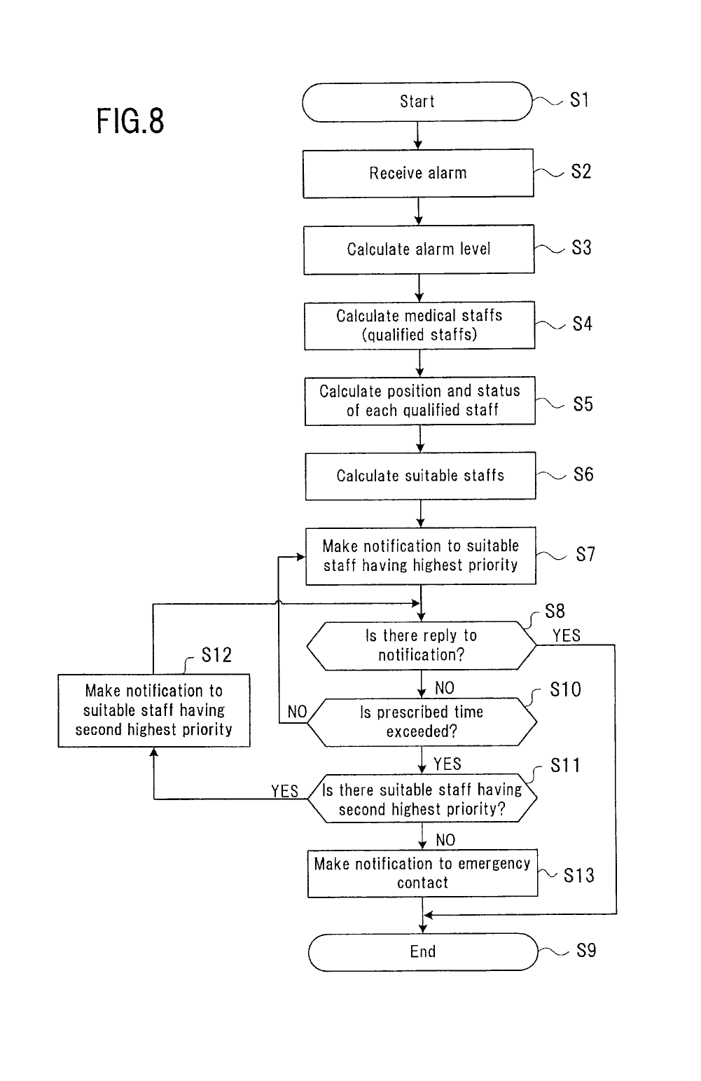

FIG. 8 is a flowchart illustrating the above-described operation. In FIG. 8, step S1 is a start step. When the support apparatus 100 receives the alarm in step S2, the alarm level determination unit 23 calculates, in step S3, the alarm level based on the disease state stored in the alarm information storage unit 14, medical information generated from the home medical equipment, and the like.

In step S4, the medical staff calculation unit 21 calculates, from among the medical staffs, the qualified staffs who can support the patient. In step S5, a current position and a current status of each qualified staffs are calculated based on the schedule information, route information, GPS, and the like. In step S6, the suitable staff calculation unit 24 calculates suitable medical staffs (suitable staffs) for the support (e.g., home visit) in a prioritizing manner based on the time required to arrive at the alarm source.

In step S7, a support request is notified to the terminal device 200 of a suitable staff having the highest priority who is calculated in step S6. In step S8, it is determined whether there is a reply from the highest-priority suitable staff. When there is a reply, this routine is ended in step S9. On the other hand, when there is no reply, a processing flow is returned from step S10 to step S7, where the notification is repeatedly made to the highest-priority suitable staff until a reply is acquired within a prescribed time length.

On the other hand, when there is no reply within a prescribed time length in step S10, the support request is notified to a suitable staff having the second highest priority in step S12, if exists. The prescribed time in step S10 changes depending on the disease state, alarm level, and the like. For example, when the alarm level is high, i.e., urgency is high, the prescribed time is set short. At the same time, the prescribed time is set to be reduced as a time elapsed from reception of the alarm is increased for early notification to the suitable staff having the next highest order of priority. The processing flow from step S8 to S12 is repeated in this manner and, when there is no reply from all the suitable staffs, i.e., there is no more suitable staff left, the processing flow proceeds to step S13. In step S13, notification is made to the emergency contact, and this routine is ended.

As described above, according to the present embodiment, an optimum doctor is calculated depending on the alarm level from the home-care patient, whereby it is possible to promptly respond to the support request from the home-care patient.

While the embodiment has been described, the embodiment has been presented by way of example only, and is not intended to limit the scope of the invention. Indeed, the novel apparatus and methods described herein may be embodied in a variety of other forms; furthermore, various omissions, substitutions and changes in the form of the apparatus and methods described herein may be made without departing from the spirit of the inventions. The accompanying claims and their equivalents are intended to cover such forms or modifications as would fall within the scope and spirit of the inventions.

What is claimed is:

1. A home medical care support apparatus comprising:
an alarm level determination unit that receives alarm information issued from a home-care patient and home medical equipment and determines an alarm level indicating a degree of urgency;
a storage unit that stores a home visit schedule of each of a plurality of medical staffs who perform medical support for the home-care patient; and
a medical staff calculation unit that calculates, from among the plurality of medical staffs who perform medical support for the home-care patient, qualified staffs who can perform the support based on route information included in the home visit schedule information and the alarm level.

2. The home medical care support apparatus according to claim 1, further comprising:
a presence calculation unit that calculates, based on the route information and schedule information on each of the qualified staffs calculated by the medical staff calculation unit, whether each of the qualified staffs can perform support for the home-care patient; and
a suitable staff calculation unit that uses a result of the calculation made by the presence calculation unit to calculate suitable staffs for supporting the home-care patient.

3. The home medical care support apparatus according to claim 2, wherein
the suitable staff calculation unit prioritizes the suitable staffs in ascending order of distance from an alarm source.

4. The home medical care support apparatus according to claim 2, further comprising a notification unit that notifies a terminal device owned by each of the suitable staffs of a support request and confirms a reply to the notification from the terminal device.

5. The home medical care support apparatus according to claim 4, wherein
the notification unit notifies the terminal device of a suitable staff having the highest priority of the support request and, when there is no reply from him or her within a prescribed time, sequentially transmits the notification of the support request to suitable staffs having the second and subsequent highest priorities, and
the prescribed time is changed depending on the alarm level.

6. The home medical care support apparatus according to claim 4, wherein
the notification unit notifies the terminal device of a suitable staff having the highest priority of the support request and, when there is no reply from him or her within a prescribed time, sequentially transmits the notification of the support request to suitable staffs having the second and subsequent highest priorities, and
the prescribed time is changed depending on a time elapsed from reception of the alarm.

7. The home medical care support apparatus according to claim 4, wherein
the notification unit makes notification to a prescribed emergency contact when there is no reply from all the suitable staffs calculated by the suitable staff calculation unit.

8. A home medical care support apparatus, comprising:
an alarm level determination unit that receives alarm information issued from a home-care patient and home medical equipment and determines an alarm level indicating a degree of urgency;
a medical staff calculation unit that calculates, from among a plurality of medical staffs who perform medical support for the home-care patient, qualified staffs who can perform the support based on medical examination information on the home-care patient and route information on each of the plurality of medical staffs and the alarm level; and
a suitable staff calculation unit that calculates suitable staffs for supporting the home-care patient in a prioritizing manner based on information on a location of each of the qualified staffs and the alarm level.

9. A home medical care support system comprising:
an alarm sending unit that sends alarm information through a home-care patient and home medical equipment;
a support apparatus that receives the alarm information from the alarm sending unit and performs support for the home-care patient; and
a terminal device that receives notification from the support apparatus and replies thereto,
the support apparatus including:
an alarm level determination unit that receives alarm information from the alarm sending unit and determines an alarm level indicating a degree of urgency;
a medical staff calculation unit that calculates, from among a plurality of medical staffs who perform medical support for the home-care patient, qualified staffs who can perform the support based on medical examination information on the home-care patient and the alarm level; and
a suitable staff calculation unit that calculates suitable staffs for supporting the home-care patient in a prioritizing manner based on information on a location of each of the qualified staffs and the alarm level.

10. The home medical care support system according to claim 9, further comprising a notification unit that notifies the terminal device owned by each of the suitable staffs of a support request according to the priority order and confirms a reply to the notification from the terminal device.

11. The home medical care support system according to claim 9, wherein
the alarm level determination unit determines the alarm level based on the number of pressing times, frequency, and time length of depression of a contact button operated by the home-care patient, as well as, based on a degree of change in vital data of the home-care patient measured by the home medical equipment, an elapsed time of the change, a rate of the change.

12. The home medical care support system according to claim 9, further comprising:
a presence calculation unit that calculates, based on route information, schedule information, and the location information on each of the qualified staffs calculated by the medical staff calculation unit, whether each of the qualified staffs can perform support for the home-care patient, wherein
the suitable staff calculation unit calculates the suitable staffs using a result of the calculation made by the presence calculation unit.

13. The home medical care support system according to claim 9, wherein
the suitable staff calculation unit prioritizes the suitable staffs in ascending order of distance from an alarm source.

14. The home medical care support system according to claim 9, wherein
the notification unit notifies the terminal device of a suitable staff having the highest priority of the support request and, when there is no reply from him or her within a prescribed time, sequentially transmits the notification of the support request to suitable staffs having the second and subsequent highest priorities, and
the prescribed time is set to be reduced as the alarm level becomes higher and a time elapsed from reception of the alarm information is increased.
